(19) United States
(12) Patent Application Publication
(10) Pub. No.: US 2025/0016101 A1
(43) Pub. Date: Jan. 9, 2025

(54) STREAM ANALYTICS PROCESSING

(71) Applicant: RADCOM LTD., Tel Aviv (IL)

(72) Inventors: Yehiel Itman, Givatayim (IL); Yaron Rahimi, Be'er Ya'akov (IL); Tomer Tuvia Ilan, Herzliya (IL)

(21) Appl. No.: 18/346,814

(22) Filed: Jul. 4, 2023

(51) Int. Cl. H04L 47/125

(52) U.S. Cl. CPC H04L 47/125; H04L 43/022

(57) ABSTRACT

A communications network, comprising: an array of load balancers and probes for monitoring operations of the network; and at least one data sketch embedded in a load balancer and/or a probe of the array that is operable to process data comprised in protocol data units (PDUs) that are streamed to the array.

### FIELD

Embodiments of the invention relate to real-time processing of data streams.

### BACKGROUND

Modern communications networks support an ever increasing gamut of communication services for very large, varied, and growing populations of human users as well as autonomous or semi-autonomous users that are devices, appliances, and machines, conventionally semantically aggregated under the rubric of “things” that access the networks via radio access networks (RANs). The communications services support user applications for human users who access the networks using any of various stationary and/or mobile user equipment (UE) and an internet of things (IoT) that provide communications between things, and between things and human users. The networks span not only global geography and global populations of human users and things, but a plethora of different methods, devices, infrastructures, and protocols for propagating data, voice, and video content generated by the human users and things. For convenience of presentation, human users and things that communicate via the networks are generically referred to as users. When advantageously distinguished, users that are human and users that are things, if not distinguished explicitly, may rely on context to be distinguished.

The enormous numbers of users and different user applications that are mediated via the networks have generated an ever growing torrent of information flows that are propagated by streams of protocol data units (PDUs) and/or data records, over geographically local and/or global, wireless, and wired network paths. The network paths are configured by physical devices and an ever increasing, if not dominant number, of virtual network entities that direct the PDUs from their sources to their destinations in accordance with different protocols over different network paths. PDUs, even of a same type and belonging to a same communication session, are often handed off to propagate between different, commodity physical devices that have been coopted by software to cooperate as components of virtual network entities. Monitoring and processing network traffic to upkeep the networks and maintain acceptable levels of quality of service (QOS) are complex and challenging tasks.

To cope with the tasks networks typically generate floods of structured data records as well as semi-structured and unstructured network and call data that characterize various aspects of network calls, transactions, and sessions traversing the networks and store the data in large composites of data referred to as data lakes. Data in a network data lake may be processed by relatively small processing programs referred to as data sketches. Data sketches scan and sample data in the lakes for processing to generate values for Key Performance Indicators (KPI) that may be used to monitor, maintain, and manage the network. The KPI values produced by data sketches are typically characterized by a fraction of relevant, “target”, data sampled, sample sizes, and statistical moments that are functions of the sample sizes. A given KPI produced by a data sketch may be a single valued function or a tuple.

Because data in data lakes may be stored in different structured and unstructured formats from different data sources it may be relatively complex to configure sketches to sample the data lakes for information relevant to their tasks. And because of the very large volumes of data that data lakes typically contain, sampling and processing information in data lakes by sketches may incur relatively large sampling latencies and require substantial compute resources.

### SUMMARY

An aspect of an embodiment of the disclosure relates to providing a real-time analytics system, optionally referred to as RETA, for monitoring a communications network in real-time. RETA comprises a plurality of data sketches embedded in load balancers and/or probes of the network, and a data processing backend. The embedded data sketches have direct access to data in PDUs and/or data records in data streams mirrored from entities in the network to the load balancers and/or probes in which sketches are embedded. The data sketches are configured to process data in the PDUs and/or data records to generate, substantially in real-time, key performance indicators (KPIs) relevant to operation of the communications network and communications that the network supports. The data sketches transmit the KPIs toward the backend for storage and/or further processing to provide desired analytics.

A PDU may be a PDU of any of the various layers of the Open Systems Intercommunication (OSI) model, such as by way of example, a frame, packet, or datagram. A data record comprises an aggregation of related data and may by way of example comprise a partial or complete record of a transaction or a communications session. PDUs and data records are referred to generically as PDUs. Embedding data sketches refers to providing the data sketches with direct access on a PDU by PDU basis to data in PDUs streaming in the load balancers or probes in which the sketches are embedded and may be accomplished by any of various methods. In an embodiment, embedding may be accomplished by integrating executable code and/or data, hereinafter referred to as software, that are required for operation of the data sketches with software of the load balancer or probe in which they are embedded. Optionally, embedding is accomplished by hooking, calling, or mirroring. In an embodiment, the load balancers, or probes in which the data sketches are embedded respectively process or decode PDUs streaming through the load balancers or probes to make data comprised in PDUs available for processing by the data sketches.

In an embodiment a data sketch embedded in a load balancer or probe is configured to be switched ON or switched OFF, for example by using “if” or “switch” statements, so that the data sketch is hot replaceable or modifiable without affecting other operations of the load balancer or probe in which the data sketch is embedded. For example, a data sketch may comprise hyperparameters that are dynamically settable by a user to configure processing PDUs and provide a value for a desired KPI. A settable hyperparameter may be settable to determine a data scanning search pattern, sampling frequency, a search period of time, and/or a value of a field in a PDU to acquire data which the data sketch processes to generate a desired KPI.

In an embodiment, data sketches are configured so that values that same type data sketches embedded in different load balancers or probes generate for a given KPI from PDUs in different data streams are aggregatable. The values may therefore be merged in real-time from data streams, optionally by an edge processor or the backend, to provide a value for the given KPI that would be expected to be produced by a single data sketch of the same type generating a value for the given KPI from all the different streams.

In an embodiment the RETA backend processes values for a set of different KPIs provided by at least one embedded data sketch for a network entity to provide an operating profile for the network entity that includes the values or functions of the values. The operating profile characterizes network communications that the entity supports and/or functioning of the entity in supporting the communications. In an embodiment the operating profile is time resolved and the backend stores the profile to record an operating history of the network entity operations as a function of time that is updated substantially in real time. Optionally, the backend processes the history to provide a time dependent normative behavior pattern that characterizes the network entity operations. In an embodiment the backend uses the normative behaviour pattern to monitor operations of the network entity and determine if current operations of the entity are unsatisfactory or anomalous, and/or to anticipate unsatisfactory or anomalous behavior of the entity operations. Optionally, the backend processes the history to determine palliative actions undertaken to moderate anomalous behavior and associate a given anomaly with a particular palliative invoked to ameliorate the anomalous behavior. Optionally if the backend detects and/or anticipates the given anomaly in real-time, the backend may alert a user to the anomaly and its associated palliative, or automatically invoke the palliative to cope with the anomaly.

It is noted that by embedding data sketches in load balancers and/or probes to configure a RETA in accordance with an embodiment of the disclosure, the RETA enables designing data sketches, optionally in real time, that generate at relatively low overhead costs in compute resources, substantially real-time values for relevant network KPIs characterized by relatively high spatiotemporal resolutions. The KPIs support production of real-time imaging of network status, and real-time automatic or human alerted intervention to maintain satisfactory operations of the network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1A schematically shows deployment of data sketches comprised in a RETA embedded in load balancers and probes of a 4G LTE communications network to monitor the network, in accordance with an embodiment of the disclosure;

FIG. 1B schematically shows deployment of data sketches comprised in a RETA embedded in load balancers and probes of a 5G communications network to monitor the network, in accordance with an embodiment of the disclosure; and

FIG. 2 schematically shows details of a portion of a RETA operating to monitor and generate KPIs, in accordance with an embodiment of the disclosure.

### DETAILED DESCRIPTION

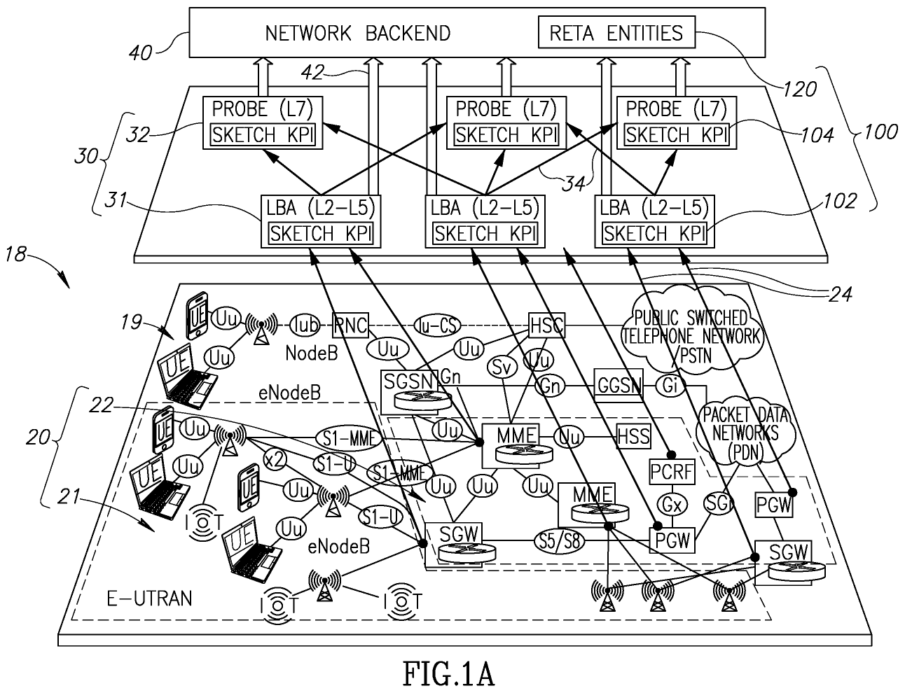

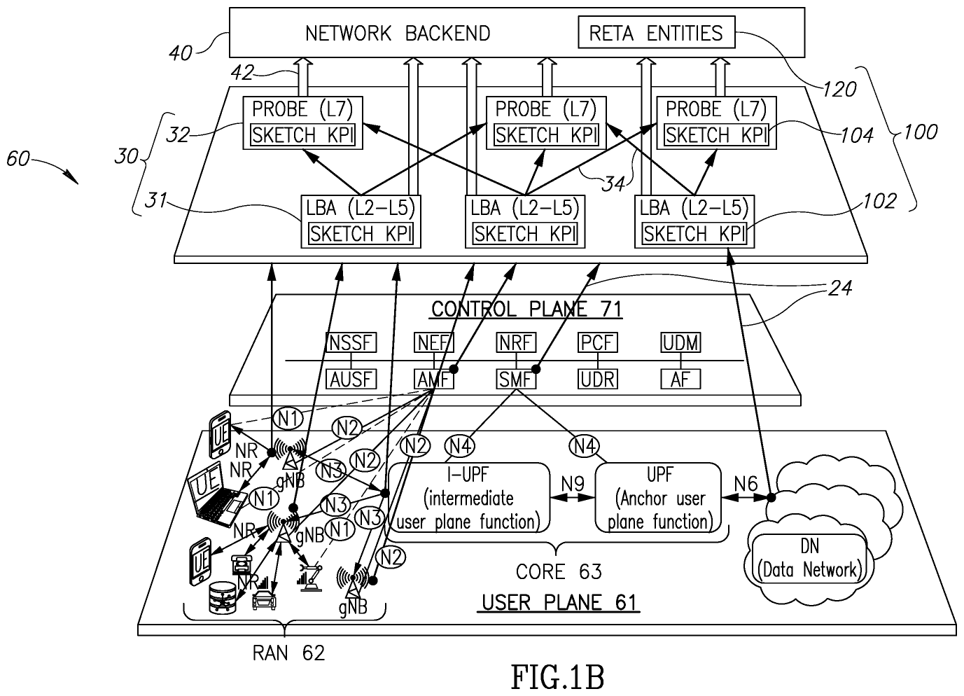

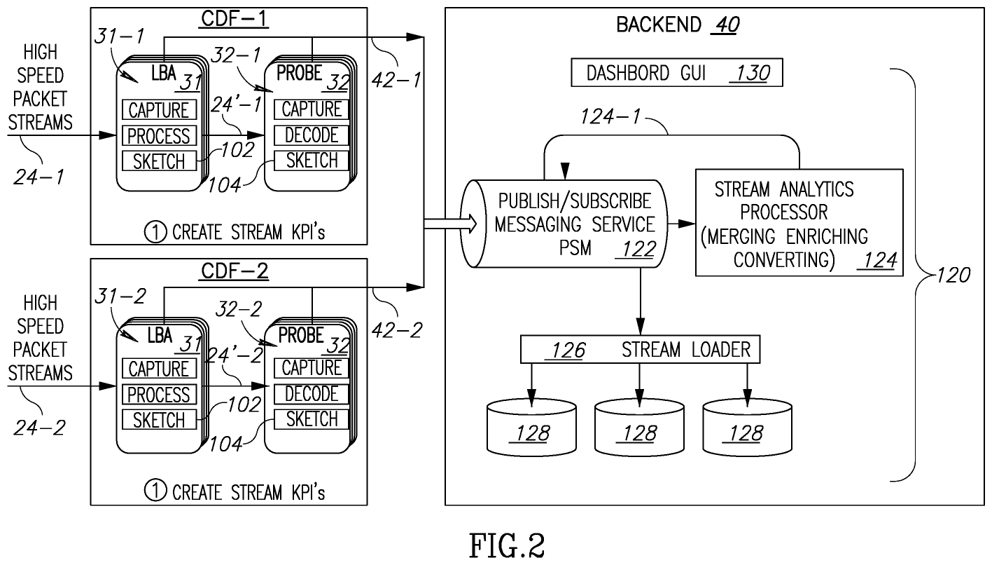

In the following detailed description, a general features of a RETA in accordance with an embodiment of the disclosure, are discussed with reference to FIGS. 1A, 1B, and 2. FIG. 1A schematically shows a RETA and embedded sketches coupled to an LTE (long term evolution) communications network to monitor the network, in accordance with an embodiment of the disclosure. FIG. 1B schematically shows a RETA and embedded sketches coupled to 5G (fifth generation) communications network to monitor the network, in accordance with an embodiment of the disclosure. FIG. 2 schematically illustrates elements of a RETA configured to process high speed PDU streams generated by a communications network to monitor operations of an LTE or 5G network, in accordance with an embodiment of the disclosure. FIG. 3 schematically shows details of a portion of a RETA processing high speed data streams, in accordance with an embodiment.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

FIG. 1 schematically shows a RETA 100 integrated with a communication network 18 to assist in monitoring and controlling the network, in accordance with an embodiment of the disclosure.

Network 18 comprises by way of example, a 3rd Generation Wireless Mobile Communication (3G) network 19 and a 4G (fourth generation) LTE (Long Term Evolution) network 20. LTE 20 comprises an Evolved Universal Terrestrial Radio Access Network (E-UTRAN) 21 and an Evolved Packet System (EPS) core communications network 22 that are delineated by dashed boundaries. E-UTRAN 21 provides user equipment with wireless radio frequency (RF) channel connectivity to EPS core network 22 via eNodeB radio base stations. EPS 22 operates to connect a user's communication equipment (UE) to one or more Packet Data Networks (PDNs) that is connected by E-UTRAN 21 to EPS 22, to the PSTN (Public Switched Telephone Network), and/or to other users.

Network 18 comprises an array 30 of bare metal or virtual LBA (load balancer appliance) load balancers 31 and probes 32 for monitoring and managing operations of network 18. LBAs 31 receive PDUs mirrored from various network entities in network 18. The LBAs distribute the received PDUs to probes 32 for processing to generate information relevant to monitoring and controlling the network and forwarding the generated information to a network backend 40. Arrows 24 schematically represent mirroring PDUs from network entities to LBAs 31. Arrows 34 schematically represent distributing PDUs to probes 32 by LBAs 31. Block arrows 42 represent forwarding information to backend 40. In FIG. 1 by way of example, PDUs are shown mirrored from Serving Gateways (SGWs), Mobile Management Entities (MMEs), and PDN Gateways (PGWs) of LTE 20.

RETA 100 comprises data sketches 102 embedded in LBAs 31, and data sketches 104 embedded in probes 32. In an embodiment, LBAs 31 are optionally configured to process layer 2 to layer 5 PDUs mirrored to the LBAs from entities in network 18 and to make processed data in the layers available to data sketches 102 for processing to provide KPIs that data sketches 102 are configured to provide. Optionally, probes 32 are configured to decode layer 5-7 encapsulations of data in mirrored PDUs received from LBAs 31 and to make the decoded data available to data sketches 104 for processing to provide KPIs that data sketches 104 are configured to provide. Data sketches 102 and 104 forward KPIs that they generate to entities comprised in backend 40, optionally referred to as RETA entities, generically referenced by a label 120, associated with processing KPIs received from data sketches 102 and 104. Block arrows 42 represent forwarding data sketch KPIs as well as other types of information generated by LBAs 31 and probes 32 to backend 40.

It is noted that each LBA 31 and probe 32 shown in FIG. 1A may respectively represent one or a cluster of LBAs and one or a cluster of probes comprised in RETA 100. For convenience of presentation reference to a cluster is considered to reference to at least one element of the cluster. Data sketches embedded in an LBA 31 and/or a probe 32 may by way of example comprise at least one or any combination of more than one of various different types of data sketches. By way of example, an LBA 31 or probe 32 may comprise at least one or any combination of more than one of: a theta sketch that estimates cardinality of PDUs in a data stream comprising a field bearing a particular key-value pair; a KLL (Karnin, Lang, and Liberty) sketch operable to provide percentile distributions for a feature such as latency that may characterize a network element or a number of sessions that a Packet Data Network Gateway (P-GW) of the network sets up as a function of time of day; or a frequency sketch that operates to determine a frequency with which UEs identified by a set of IMSIs (International Mobile Subscriber Identity) engage in sessions via the network.

FIG. 1B schematically shows RETA 100 coupled to network entities (NEs) of a 5G network 60 in accordance with an embodiment of the disclosure. 5G network 60 implements control and user plane separation (CUPS) and comprises a user plane (UP) 61 and a control plane (CP) 71.

User plane 61 provides communication channels to connect UEs to intended destination data networks (DNS) with which users of the UEs are interested in communicating and is responsible for propagating data PDUs between the UEs and DNs over the channels. The user plane comprises a radio access network (RAN) 62 having radio base stations, gNBs. The gNBs communicate with the UEs over RF communication channels using an NR interface and connect the UEs to a core network 63 using an N3 interface. The core network operates to connect the gNBs and thereby the UEs to the DNs and comprises an intermediate user plane function (I-UPF) and an anchor user plane function UPF. The I-UPF communicates directly with RAN gNBs using the N3 interface and communicates with the UPF using an N9 interface. The UPF uses an N6 interface to connect the core network with the external DNs to provide communication between the UEs and intended DNs.

Control plane 71 comprises a plurality of control plane (CP) network elements (NEs) that the control plane invokes to manage the network and operation of user plane 61 in establishing, maintaining, and terminating communication sessions between UEs and DNs. The plurality of network functions comprise a: Mobility Management Function (AMF); Network Repository Function (NRF); Session Management Function (SMF); Unified Data Repository (UDR); Policy Control Function (PCF); Unified Data Management (UDM); Network Slice Selection Function (NSSF); and Authenticate Server Function (AUSF). In addition, the control plane also may have an Application Function (AF) which enables service providers to interact with a Network Exposure Function (NEF) to create their own 5G control plane functions.

The control plane functions communicate with each other via a control plane bus 72 using various control plane interfaces. The control plane Mobility Management Function, AMF, uses an N1 interface to communicate with UEs accessing the 5G network and uses the N3 interface to communicate with network gNBs. The I-UPF and UPF communicate with the control plane SMF using an N4 interface.

FIG. 1B schematically shows by way of example that array 30 of LBAs 31, probes 32, and data sketches 102 and 104 are coupled to receive and process PDU streams mirrored from user plane 61 network entities using interfaces N1, N3, or N6, and from control plane 71 entities AMF and UPF. As in the case of network 18 and 4G network 20, each LBA 31 and probe 32 shown in FIG. 1B may represent an LBA and a probe cluster respectively comprised in RETA 100 that is coupled directly or indirectly to entities in network 60. Data sketches embedded in an LBA 31 and/or a probe 32 coupled to NEs of 5G network 60 may by way of example comprise at least one or any combination of more than one type of a data sketch such as by way of example, a theta sketch; a KLL sketch, or a frequent items sketch.

FIG. 3 schematically shows details of a portion of a RETA system 102, similar to RETA system 100 and comprising RETA entities 120, operating to monitor and generate KPIs for communications propagated in, optionally 5G network 60 (FIG. 1B), in accordance with an embodiment of the disclosure.

RETA 102 comprises a plurality of, optionally two, network monitoring groups, optionally referred to as content delivery functions (CDFs), CDF-1 and CDF-2 and a backend 40. The CDFs receive high speed PDU streams, optionally packet streams, from entities in 5G network 60 and generate KPIs from data in the packets for monitoring and controlling different portions of network. The CDFs may forward the KPIs to backend 40 for further processing and storage.

CDF-1 comprises a cluster 31-1 of at least one LBA 31 and a cluster 32-1 of at least one probe 32 that cooperate to acquire and/or process data in packets comprised in a packet stream 24-1 from the first portion of network 60 to generate and forward network KPIs in a KPI data stream 42-1 to backend 40, in accordance with an embodiment of the disclosure. In an embodiment, each LBA in LBA cluster 31-1 comprises LBA software having at least one embedded sketch 102 for generating network KPIs. The LBA software is configured to capture and process packets in packet stream 24-1 to make data contents of the packets in at least one or any combination of, optionally, two or more of OSI layers 2 to 5, available to the at least one sketch 102 and to load balance the packets to probes 104 in packet streams 24′-1 in accordance with any of various advantageous load balancing algorithms. The at least one embedded sketch 102 may process data in any one or any combination of two or more layers 2 to 5 to generate desired KPIs and forwards the KPIs to backend 40 in data stream 42-1. Each probe 32 in probe cluster 32-1 comprises probe software having at least one embedded sketch 104. The probe software is configured to capture and decode load balanced packets it receives in data stream 24′-1 to make data contents in, optionally, OSI layers 6 and 7 of the packets available to the at least one sketch. The at least one sketch 104 may process data in any one or both of layers 6 and 7 to generate desired KPIs and forward the KPIs to backend 40 in KPI data stream 42-1.

CDF-2 is optionally configured similar to and operates similarly to CDF-1 to process packets in data stream 24-2 from the second portion of network 60 to generate network KPIs and forward the KPIs in a KPI data stream 42-2 to backend 40, in accordance with an embodiment of the disclosure. CDF-2 optionally comprises a cluster 31-2 of at least one LBA 31 and a cluster 32-2 of at least one probe 32. LBA cluster 31-2 receives packet stream 24-2 and load balances the packets in the stream to probes 32 in cluster 32-2. Optionally data sketches 102 in LBA cluster 31-2 process data in OSI layer 2-5 to produce KPIs and data sketches 104 process data in one or both OSI layers 6 and 7 to produce KPIs.

RETA 102 optionally comprises in backend 40 RETA entities 120 such as a publish/subscribe message service (PSM) entity 122, for example a Kafka cluster, a stream analytics processor 124, a stream loader 126, one or more optionally different types of memories 128, for example a columnar memory and a semi-structured and/or structured data memory, and a dashboard 130 for interfacing a user with the RETA entities and 120 and sketches 31 and 32. PSM 122 receives data streams 42-1 and 42-2 comprising KPIs produced by sketches 102 and 104 in CDF-1 and CDF-2 and forwards and distributes the KPI data streams as may be needed to analytics processor 124 and stream loader 126. By way of example, PSM 122 may forward KPIs from streams 42-1 and 42-2 to analytics processor 124 and the processor may operate to merge, enrich, and/or convert data in the KPIs. For example, if data sketches in CDF-1 and CDF-2 generate and stream KPIs in KPI data streams 42-1 and 42-2 that comprise frequency counts of error code packets for various user and/or control plane functions in the respective first and second portions of 5G network 60, processor 124 may merge the frequency counts to provide frequency counts for all of the network. Processor 124 may enrich the frequency counts by augmenting error codes identifying different types of errors with corresponding user readable names and convert the merged data to a suitable format for storage in one or more of memories 128. The processor may return the enriched and formatted analytic data in an analytic data stream 124-1 to PSM 122 for distribution of the data to the one or more of suitable memories 128.

In an embodiment GUI 130 is configured to enable a user to access and observe data stored in memories 128, receive from analytics processor 124 analytic data streams comprising data processed by analytics processor 124, and access and configure a RETA entity 120, and/or data sketches 31 and 32 embedded LBAs 31 and probes 32 of CDFs-1 and -2.

By way of example, if a data sketch 31 or 32, comprises a count data sketch that generates a value for a KPI that is a frequency for a feature of a 5G function or a component bare metal or virtual element of a 5G function, in accordance with an embodiment a user may use GUI 130 to configure the data sketch to sample the frequency at different advantageous sampling frequencies and/or for different sampling period durations. Optionally RETA is configured to enable the user to change the sampling frequency or sampling period duration in real-time without affecting the LBA or probe in which it is embedded by switching off the count data sketch so that at least a portion of the sketch is detoured and does not execute while making the change.

In an embodiment, a data sketch may be programmed to automatically reconfigure itself dynamically in real-time in response to a value of a KPI that the data sketch generates. For example, in accordance with an embodiment if a data sketch 31 or 32 comprises a KLL sketch that provides a percentile histogram having particular bin widths, the data sketch may be configured to automatically reduce bin widths to provide a histogram with greater resolution if a value for an upper bound of a bin is greater than a predetermined upper bound.

In an embodiment RETA backend analytics processor 124 processes values for KPIs streamed to backend 40 by at least one embedded data sketch 31 or 32 for a network entity to provide operating profile records that provide indications of status of operations of the network entity as a function of time of day (ToD) and network operating conditions. The analytic processor optionally processes the profile records to determine normative operating profiles that characterize normal behaviour of the network entity as a function of time of day (ToD) and operating conditions. The processor may monitor the network entity operations in real-time to identify anomalies in performance of the network entity by comparing an operating profile of the entity at a current ToD with a normative profile or profiles for the entity at substantially corresponding ToDs. Comparisons may by way of example be made in accordance with any of various similarity algorithms such as a cosine similarity algorithm or by a classifier, optionally a deep neural network (DNN).

In the event of identifying an anomaly, RETA 102 may generate an alarm notifying a user of a possible need for user intervention to deal with the anomaly. In an embodiment RETA may be configured to automatically undertake an action on its own to deal with an anomaly. For example, for a type of anomaly that has been experienced by network 60 and for which a successful remedial procedure has been practised, RETA may be configured undertake the procedure and/or to signal an appropriate backend network controller (not shown) to undertake the procedure.

There is therefore provided in accordance with an embodiment of the disclosure a communications network, comprising: a plurality of network elements that support communications propagated by the network; an array of load balancers and probes that receive streams of protocol data units (PDUs) and process the PDUs to monitor operations of the network; at least one data sketch embedded in a load balancer and/or a probe of the array that is operable to process data comprised in a stream of PDUs received by the load balancer and/or probe as the PDUs stream through load balancer and/or probe to generate a stream of values for key performance indicators (KPIs) of the network; and a back end that receives and processes the received stream of KPI values to generate analytic data relevant to operations of the network. Optionally, the load balancer and/or probe processes the streaming PDUs to make the data contained in the PDUs available for processing by the at least one sketch. Optionally, the at least one data sketch comprises a first data sketch embedded in a load balancer of the array. Optionally, the load balancer in which the first data sketch is embedded processes the received PDUs to make data comprised in the PDUs from a selection of OSI (Open System Interconnection) model layers available to the first data sketch embedded in the load balancer. Optionally, the selection of OSI layers comprises at least one or any combination of more than two of layers two to five.

In an embodiment, the at least one data sketch comprises a second data sketch of the at least one data sketch embedded in a probe of the array. Optionally, the probe in which the second data sketch is embedded processes the received PDUs to make data comprised in the PDUs from a selection of OSI layers available to the second data sketch embedded in the probe. Optionally, the selection of OSI layers comprises layer six and/or layer seven.

In an embodiment, the at least one data sketch comprises a switch operable to interrupt processing of the data by the at least one data sketch to enable the at least one data sketch to be hot replaced or configured in real-time without interfering with non-sketch operations of the load balancer and/or probe in which the at least one sketch is embedded.

In an embodiment, the at least one data sketch comprises a plurality of data sketches. Optionally, the backend processes values in the received KPIs from different data sketches of the plurality of sketches to merge the values to generate the analytics data. Additionally or alternatively, the backend processes values from different KPIs to generate a normative operating profile of an entity of the network as a function of time. Optionally, the backend processes a current operating profile of the entity and the normative operating profile to detect an anomaly in operations of the entity. Optionally, the backend generates an alert responsive to detecting the anomaly to notify a user of the network of the anomaly. The communications network, according to claim 13 or claim 14 wherein the backend initiates a palliative activity to ameliorate the anomaly responsive to identifying the anomaly.

There is further provided in accordance with an embodiment a load balancer configured to load balance PDUs in a stream of PDUs of a communications network and comprising an embedded data sketch that is operable to process data comprised in the stream of PDUs to generate a stream of values for a key performance indicator of the network as the PDUs stream through load balancer.

There is further provided in accordance with an embodiment a probe configured to process data in PDUs in a stream of PDUs of a communications network and comprising an embedded data sketch that is operable to process data comprised in the stream of PDUs to generate a stream of values for a key performance indicator of the network as the PDUs stream through the probe.

There is further provided in accordance with an embodiment a method for real-time monitoring a communications network having an array of load balancers and probes for processing streams of PDUs that propagate through the network, the method comprising: embedding a plurality of data sketches in the load balancers and/or probes of the array that are operable to process data in the PDUs in real-time as the PDUs stream through the load balancers and/or probes to generate streams of values for KPIs of the network; and using the values of the KPIs to monitor the network in real-time. Optionally, the method comprises using the values of the KPIs to control the network in real-time.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A communications network, comprising:
a plurality of network elements that support communications propagated by the network;
an array of load balancers and probes that receive streams of protocol data units (PDUs) and process the PDUs to monitor operations of the network;
at least one data sketch embedded in a load balancer and/or a probe of the array that is operable to process data comprised in a stream of PDUs received by the load balancer and/or probe as the PDUs stream through load balancer and/or probe to generate a stream of values for key performance indicators (KPIs) of the network; and
a back end that receives and processes the received stream of KPI values to generate analytic data relevant to operations of the network.

2. The communications network, according to claim 1 wherein the load balancer and/or probe processes the streaming PDUs to make the data contained in the PDUs available for processing by the at least one sketch.

3. The communications network, according to claim 2 wherein the at least one data sketch comprises a first data sketch embedded in a load balancer of the array.

4. The communications network, according to claim 3 wherein the load balancer in which the first data sketch is embedded processes the received PDUs to make data comprised in the PDUs from a selection of OSI (Open System Interconnection) model layers available to the first data sketch embedded in the load balancer.

5. The communications network, according to claim 4 wherein the selection of OSI layers comprises at least one or any combination of more than two of layers two to five.

6. The communications network, according to claim 2 wherein the at least one data sketch comprises a second data sketch of the at least one data sketch embedded in a probe of the array.

7. The communications network, according to claim 6 wherein the probe in which the second data sketch is embedded processes the received PDUs to make data comprised in the PDUs from a selection of OSI layers available to the second data sketch embedded in the probe.

8. The communications network, according to claim 7 wherein the selection of OSI layers comprises layer six and/or layer seven.

9. The communications network, according to claim 1 wherein the at least one data sketch comprises a switch operable to interrupt processing of the data by the at least one data sketch to enable the at least one data sketch to be hot replaced or configured in real-time without interfering with non-sketch operations of the load balancer and/or probe in which the at least one sketch is embedded.

10. The communications network, according claim 1 wherein the at least one data sketch comprises a plurality of data sketches.

11. The communications network, according to claim 10 wherein the backend processes values in the received KPIs from different data sketches of the plurality of sketches to merge the values to generate the analytics data.

12. The communications network, according to claim 10 wherein the backend processes values from different KPIs to generate a normative operating profile of an entity of the network as a function of time.

13. The communications network, according to claim 12 wherein the backend processes a current operating profile of the entity and the normative operating profile to detect an anomaly in operations of the entity.

14. The communications network, according to claim 13 wherein the backend generates an alert responsive to detecting the anomaly to notify a user of the network of the anomaly.

15. The communications network, according to claim 13 wherein the backend initiates a palliative activity to ameliorate the anomaly responsive to identifying the anomaly.

16. A load balancer or probe configured to process PDUs in a stream of PDUs of a communications network and comprising an embedded data sketch that is operable to process data comprised in the stream of PDUs to generate a stream of values for a key performance indicator of the network as the PDUs stream through load balancer or probe.

17. A method for real-time monitoring a communications network having an array of load balancers and probes for processing streams of PDUs that propagate through the network, the method comprising:
embedding a plurality of data sketches in the load balancers and/or probes of the array that are operable to process data in the PDUs in real-time as the PDUs stream through the load balancers and/or probes to generate streams of values for KPIs of the network; and
using the values of the KPIs to monitor the network in real-time.

18. The method according to claim 17 and comprising using the values of the KPIs to control the network in real-time.
